(19) United States
(12) Patent Application Publication
(10) Pub. No.: US 2008/0120945 A1
(43) Pub. Date: May 29, 2008

(54) Parts kit

(75) Inventors: Richard Holbrook, Pasadena, CA (US); Darren Mark, Valencia, CA (US); Paul Schmucker, Pasadena, CA (US)

Correspondence Address: WOLF GREENFIELD & SACKS, P.C., 600 ATLANTIC AVENUE, BOSTON, MA, 02210-2206, US

(73) Assignee: Staples, The Office Superstore LLC, Framingham, MA (US)

(21) Appl. No.: 11/586,317

(22) Filed: Oct. 25, 2006

(51) Int. Cl. B65D 71/00; B26D 7/27

(52) U.S. Cl. 53/396; 206/223

(57) ABSTRACT

A kit and method for assembling an item, such as assembly-required furniture, is provided. The kit includes a plurality of parts and a plurality of compartments for packaging the parts. The parts packaged in a first compartment are used in a first assembly step, and the parts packaged in a second compartment are used in a second assembly step. This kit and method may be used to simplify the process of assembling various types of items such as furniture, toys, games and decorations as well as other various assembly-required items.

### FIELD OF INVENTION

The present application relates to a kit for assembling an item, such as furniture, and a method of packaging parts which are used in the process of assembling the item.

### BACKGROUND OF INVENTION

A variety of items, such as furniture, is purchased by consumers, and then requires some assembly once the item is removed from its box or outer packaging. Many items are sold in a disassembled state to reduce the manufacturing and shipping costs. A representative list of some typical assembly-required items includes various types of furniture, including desks, chairs, bookcases, tables and shelves.

Many consumers become aggravated and frustrated with items which require additional assembling because the assembly process can be confusing and may also be time consuming. Most assembly-required items include a list of assembly instructions which is commonly included either on a sheet of paper or on the side of the box. Some or all of the parts needed to assemble the item are typically packaged in one plastic bag or are loosely contained inside the box. To assemble the item, the consumer typically removes all of the contents from the box. Then he/she finds which parts are needed for each step and assembles the item step by step by following the instructions.

### SUMMARY OF INVENTION

In one embodiment of the present invention, a package for holding a plurality of parts is provided. The package includes a first compartment holding parts used during a first portion of assembly of an item, and a second compartment holding parts used during a second portion of assembly of an item.

In another embodiment, a kit for assembling an item is provided. The kit includes a plurality of parts, and a plurality of compartments for packaging the plurality of parts, where the plurality of compartments include at least a first compartment and a second compartment. The parts packaged in the first compartment are used in a first assembly step, and parts packaged in the second compartment are used in a second assembly step.

Yet another embodiment of the present invention is a method of packaging a plurality of parts for assembling an item. A plurality of parts and a plurality of compartments for packaging the plurality of parts is provided, where the plurality of compartments include a first compartment and a second compartment. The plurality of parts is placed in the plurality of compartments, where parts placed in the first compartment correspond to the parts utilized in a first assembly step, and parts placed in the second compartment correspond to the parts utilized in a second assembly step.

### BRIEF DESCRIPTION OF DRAWINGS

The foregoing and other items and advantages of the present invention will be appreciated more fully from the following drawings, wherein like reference characters designate like features, in which:

FIG. 1 is a top plan view of a parts kit in accordance with one illustrative embodiment of the present invention;

FIG. 2 is a perspective view of an assembled item in accordance with another illustrative embodiment of the present invention;

FIG. 3 is a top plan view of a parts kit in accordance with another illustrative embodiment of the present invention;

FIG. 4 is a top plan view of a portion of the parts kit illustrated in FIG. 3; and

FIG. 5 is a top plan view of a parts kit in accordance with yet another illustrative embodiment of the present invention.

### DETAILED DESCRIPTION

Applicant has recognized that although assembly-required items may reduce shipping and manufacturing costs, there is a need for assembly-required items which are more user-friendly to the consumer during the assembly process. Applicant has also recognized that even when the assembly instructions are detailed, carefully explained, and/or include drawings to help illustrate each assembly step, often times, the assembly process is still time consuming and may be difficult. One reason the assembly process may be time consuming is that a consumer may spend a substantial amount of time initially locating the parts needed for each assembly step. As mentioned above in the Background section, parts are typically enclosed in one large plastic bag or container, or like parts are placed together regardless of when the parts are needed during the assembly process. The consumer typically empties the contents of the bag out onto a surface, and then searches to find each part. Sometimes similar looking parts are used in different assembly steps, and the consumer may inadvertently try to assemble the item with the incorrect part.

Accordingly, aspects of the present invention are directed to an assembly-required item which is more user-friendly to consumers. In particular, the parts needed for various steps or portions of the assembly process are located together. Therefore, one does not have to spend much time sorting through all of the parts to find the proper part needed for each step. For example, in one embodiment, all of the parts needed for a first step in the assembly process are all packaged together in a first compartment.

Aspects of the present invention are also directed to a kit for an assembly-required item which reduces the amount of time a consumer spends assembling the item. Because one compartment may hold parts used during a first portion of the assembly of an item, a consumer will not waste time during the first portion of the assembly searching for parts. Similarly, a second compartment may hold parts used during a second portion of the assembly of an item. Thus, a consumer will already have all of the parts necessary for the second portion of the assembly as soon as they open up the second compartment. Other aspects of the invention are directed to a method of packaging a plurality of parts which are used to assemble an item, and also to a package used to hold the parts.

Certain aspects of the present invention relate to assembly-required items such as furniture. Some examples of assembly-required furniture include desks, tables, chairs, bookcases, shelves, etc. Other types of non-furniture assembly-required items are also contemplated by the present invention. Such items may include, but are not limited to items such as toys, games, decorations, etc. Although some of the description below is specific to assembly-required furniture, the present invention also contemplates incorporating these novel features in other types of assembly-required items.

Turning now to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

In FIG. 1, a parts kit 10 is illustrated. The parts kit 10 includes a plurality of compartments 20 which hold a variety of parts 40 used to assemble an item. The parts kit 10 of FIG. 1 illustrates three compartments 40, including a first compartment 30, a second compartment 32 and a third compartment 34, but the invention is not limited to any particular number of compartments or to the size and/or shape of the compartments. A list of instructions (not shown) may also be included to explain how the parts 40 are utilized to assemble an item. The instructions may include a plurality of assembly steps. For example, the instructions associated with the parts kit 10 illustrated in FIG. 1 may include at least three assembly steps. According to one embodiment of the present invention, the parts 40 within the first compartment 30 correspond to the parts used in the first assembly step, and the parts 40 within the second compartment 32 correspond to the parts used in the second assembly step. Furthermore, the parts 40 within the third compartment 34 correspond to the parts used in the third assembly step. However, it should be appreciated that other embodiments may be configured differently. Also, as shown in FIG. 1, unlike parts may be in each compartment and like parts may be in different compartments.

According to one embodiment, the present invention greatly simplifies the process of assembling an item. Because the parts 40 corresponding to each assembly step are located within a single compartment, the user may simply open each compartment in consecutive order to complete each assembly step. This may reduce the amount of time it takes for a user to complete the assembly process, because the user does not need to spend much time looking for each part that is needed for each step. This is in contrast to prior assembly kits and instructions which may package all or most of the parts needed for the assembly steps in one big bag which requires the user to sort though the bag to find each part. This is also in contrast from prior art kits which allocates like parts together.

As shown in FIG. 1, the various parts held inside of the compartments 20 may include various types of hardware, including screws, nuts, bolts, nails, anchors, washers, cams, pins, dowels, an Allen wrench, etc. It should be appreciated that the types of parts 40 held inside of the compartments 20 will vary based upon the particular item being assembled and the invention is not so limited. The above exemplary list is only intended to illustrate some of the parts which may be required during some assembly processes, and thus is not intended to be limiting. Furthermore, the various parts illustrated in FIG. 1 are also intended only to be representative, as the present invention is not limited in this respect. It should be appreciated that the specific parts illustrated in FIG. 1 do not correspond to a particular set of instructions, nor do these parts correspond to the assembly of a particular item.

The compartments 20 shown in the embodiment illustrated in FIG. 1 are substantially rectangularly shaped and may be formed from relatively see-through plastic sheets or sleeves, selectively sealed to form a plurality of bags or pouches. The particular compartments illustrated in FIG. 1 are formed in a linear arrangement adjacent to one another, but the invention is not so limited. These compartments 20 are each formed by a sealed perimeter 22, with two adjacent compartments 20 sharing a sealed edge 24. In this embodiment, the first compartment 30 is separated from the second compartment 32 at edge 24 with a seam line which may be formed by heat sealing and/or with an adhesive. However, as discussed below, in other embodiments, the compartments may be configured and arranged differently.

As shown in FIG. 1, each compartment 20 may also include an identifier, such as a label 28 to illustrate the step in the assembly process which corresponds to each compartment 20. The labels 28 shown in FIG. 1, specify “Step 1” for the first compartment 30, “Step 2” for the second compartment 32, and “Step 3” for the third compartment 34. However, in other embodiments, the labels 28 may include other markings to indicate the corresponding assembly step. Furthermore, the compartment may or may not be labeled and the present invention is not limited in this respect.

The identifier may be arranged inside or outside of the compartment 30, and it is also contemplated that the identifier could be formed into the material which forms the compartments. The identifier could be a label which adheres to either an inside or outside surface of the compartment 30. As discussed below, in other embodiments, the identifier could be in the form of a card placed inside of the compartment.

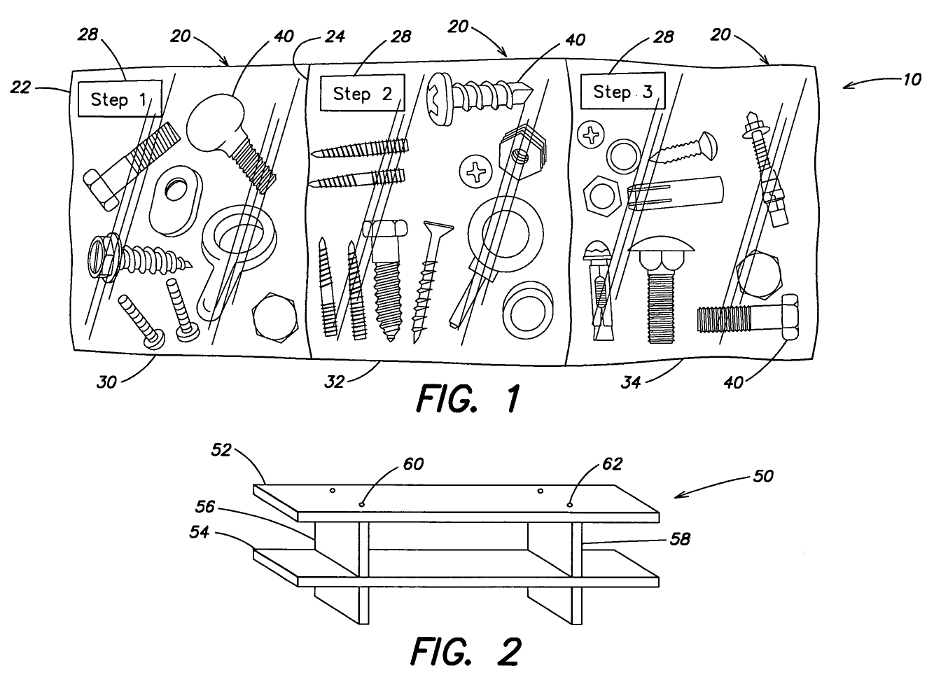

FIG. 2 illustrates one type of item, such as shelves 50 which may be packaged and/or assembled from a kit having the above-described parts kit 10. For example, connectors 60, 62 may be packaged in various compartments 30 based upon the order of the assembly steps as described above. It should be understood that additional connectors (not shown) may be used to assemble the shelves 50. This particular type of shelves 50 includes a plurality of substantially rectangular panels 52, 54 which form the horizontal shelves, and vertical supporting panels 56, 58. These panels may be formed from a material such as wood or plastic. It should be appreciated that because the panels 52, 54, 56, 58 are larger, they may not be packaged within a compartment 20, but rather, they may be packaged outside of the compartments 20. In some embodiments, the small parts are packaged within the compartments 20 while the large parts are packaged outside of the compartments 20. This particular type of shelving may be configured to stack with other shelves which may also be assembled with a parts kit 10.

As mentioned above, the parts kit 10 of the present invention may be used to assemble various types of items. In addition to the shelves depicted in FIG. 2, the parts kit 10 may also be used with other types of furniture, such as a chair, a desk, a table, a bookcase, etc.

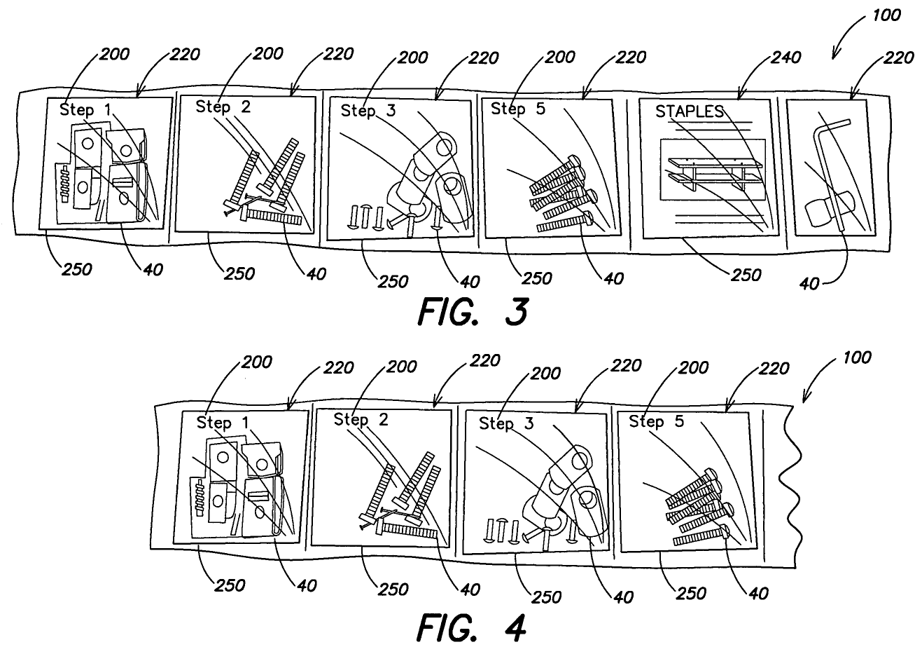

FIGS. 3 and 4 illustrate another embodiment of a parts kit 100 of the present invention. Similar to the parts kit 10 shown in FIG. 1, the embodiment of FIGS. 3 and 4 shows a parts kit 100 with a plurality of compartments 220 which hold various types of parts 40. This particular parts kit 100 also includes a card 250 inside of each compartment 220. The cards 250 may provide structure to the compartment, and as mentioned above, the cards may also include an identifier, such as marking 200, to indicate the step in the assembly process which corresponds to each compartment 220. As shown more clearly in FIG. 4, the markings 200 include “STEP 1”, “STEP 2”, “STEP 3” and “STEP 4”, where the parts 40 located in each compartment 220 correspond to each step in the assembly process. Alternately, the markings could also include simply “1”, “2” and “3”, or “A”, “B” and “C” or other conventional markings.

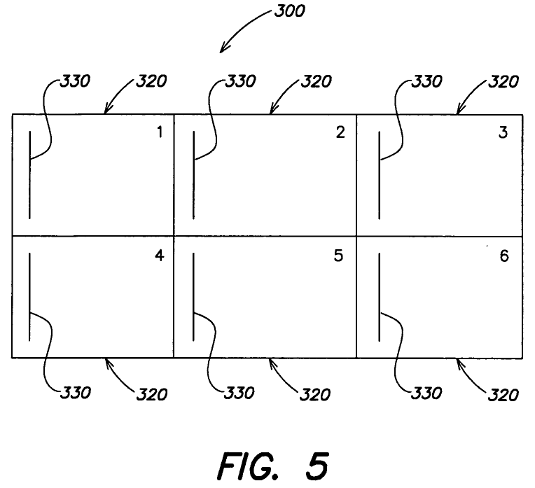

Turning to FIG. 5, another embodiment of a parts kit 300 is illustrated. For simplification, the parts 40 have been omitted from FIG. 5. As shown, parts kit 300 includes a plurality of substantially square shaped compartments 320 arranged in two rows and three columns. It should be appreciated that the specific number of rows and columns may vary based upon the total number of assembly steps for a particular assembly process. For example, in other embodiments, the parts kit may be arranged with 1-10 rows and 1-10 columns. The size, shape and arrangement of the compartments also may vary.

As mentioned above, the parts kit 10 shown in FIG. 1 has compartments 20 formed by a sealed perimeter 22, with two adjacent compartments 20 sharing a sealed edge 24. To access the parts 40 within a compartment 20, the material forming the compartments 20 is either ripped, cut or separated, for example at either the perimeter 22 or the edge 24. In contrast, the parts kit 300 shown in FIG. 5 includes reclosable compartments 320. In particular, each compartment 220 may include an opening 330 which include a closure device (not shown) such as for example, a zipper, a sliding Ziploc® seal, snaps, magnetic closures, etc. In this embodiment, each compartment 220 may be opened to remove some of the parts and then closed again to keep any remaining parts within the compartment.

The compartments may be formed from a variety of materials. For example, in one embodiment, the compartments are formed from a flexible container. The flexible container may be formed from a flexible material such as a plastic sheet or sleeve. Dividers, such as sealed edges may separate the first compartment from the second compartment in the flexible container. In other embodiments, the divider separating two compartments may include an additional layer of flexible material, such as a plastic divider wall. When the parts kit is formed from a flexible container, the plurality of compartments may resemble a plurality of bags or pouches. However, in other embodiments, it is contemplated that the parts kit be formed of a non-flexible or rigid container. Furthermore, in some embodiments, it may be desirable for the material forming the compartments to include a transparent or translucent material such that a user can see the parts 40 inside of each compartment. However, in other embodiments, the compartments may be entirely or partially opaque.

The above-described embodiments illustrate substantially squarely or rectangularly shaped compartments. These shapes may be desirable due to ease of construction, however, it should be appreciated that compartments having other shapes, is also contemplated by the present invention. Furthermore, the above-described embodiments illustrate parts kits where each compartment is substantially the same size and shape as the other compartments in the part kit. In other embodiments, the plurality of compartments forming a parts kit may vary in shape and size. For example, in one embodiment, when the number of parts needed for a particular step in an assembly process is much greater than the number of parts needed for each of the other assembly steps, or if the size of the parts for a particular assembly step is much larger than for other steps, the compartment corresponding to that particular assembly step may be larger.

Additionally, as shown in FIG. 3, at least one compartment 220 in the parts kit 100 may be used for advertising or informational purposes. For example, compartment 240 does not include any parts 40, but rather includes a card 250 which includes information about the assembled item, such as a sketch of the assembled item.

The present invention also contemplates a method of packaging a plurality of parts for assembling an item. The method includes the steps of providing a plurality of parts, and providing a plurality of compartments for packaging the parts. The plurality of compartments include a first compartment and a second compartment. Instructions may be provided to assemble the item, where the instructions include at least a first assembly step and a second assembly step. The plurality of parts are placed in the plurality of compartments, where the parts placed in said first compartment correspond to the parts utilized in the first assembly step, and the parts placed in the second compartment correspond to the parts utilized in said second assembly step. In certain embodiments, parts for multiple consecutive steps may be placed in the same compartment or within sub-compartments within a compartment.

When the plurality of parts which form an item are packaged under the above-described method, the assembly process will be simplified for a user assembling the item. In particular, the user simply opens up the first compartment to complete the first assembly step and then opens up the second compartment to complete the second step. This process may be repeated for the total number of compartments in the parts kit. Depending upon the specific assembly instructions, it is contemplated that the second assembly step may be performed before the first assembly step. Therefore, the second compartment may be opened before the first compartment. However, in some embodiments, it may be desirable and/or necessary to complete the first assembly step prior to the second assembly step. In such embodiments, the instructions may indicate that one should first remove the parts within said first compartment, and thereafter remove the parts within said second compartment after the first assembly step is completed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A package for holding a plurality of parts, the package comprising:
a first compartment holding parts used during a first portion of assembly of an item; and
a second compartment holding parts used during a second portion of assembly of an item.

2. The package of claim 1, wherein the first portion of assembly of an item is a first step in the assembly process of the item.

3. The package of claim 2, wherein the second portion of assembly of an item is a second step in the assembly process of the item.

4. The package of claim 3, wherein the first step is before the second step.

5. The package of claim 1, further comprising instructions for assembling the item, wherein said instructions include at least a first portion of assembly of the item and a second portion of assembly of the item.

6. A kit for assembling an item, the kit comprising:
a plurality of parts;
a plurality of compartments for packaging said plurality of parts, wherein said plurality of compartments include at least a first compartment and a second compartment;
wherein parts packaged in said first compartment are used in a first assembly step, and parts packaged in said second compartment are used in a second assembly step.

7. The kit of claim 6, further comprising instructions for assembling the item with said plurality of parts, wherein said instructions include at least the first assembly step and the second assembly step.

8. The kit of claim 6, wherein said plurality of parts includes small parts packaged within said plurality of compartments, and large parts which are packaged outside of said plurality of compartments.

9. The kit of claim 8, wherein said large parts include substantially rectangular panels which are secured together to assemble the item.

10. The kit of claim 6, wherein the item is a furniture item.

11. The kit of claim 7, wherein said instructions further include a third assembly step, said plurality of compartments include a third compartment, and the parts packaged in said third compartment are used in said third assembly step.

12. The kit of claim 6, wherein at least a portion of said plurality of parts is selected from the group consisting of screws, nuts, bolts, nails, anchors, washers, cams, pins, dowels, and an Allen wrench.

13. The kit of claim 6, wherein said first compartment is adjacent to said second compartment.

14. The kit of claim 6, wherein said plurality of compartments are formed from a flexible container, wherein said first compartment is separated from said second compartment with a divider in said flexible container.

15. The kit of claim 14, wherein said flexible container is formed from at least one plastic sheet forming a bag, and said divider includes a seam line separating said first compartment from said second compartment.

16. The kit of claim 15, wherein said plastic sheet is heat sealed to form said seam line.

17. The kit of claim 6, further comprising an identifier associated with each of said first and second compartments, wherein each identifier indicates the assembly step corresponding with the parts packaged in each compartment.

18. The kit of claim 17, wherein said identifiers associated with each of said first and second compartments are positioned within each compartment.

19. The kit of claim 6, wherein said first and second compartments are reclosable compartments.

20. The kit of claim 11, wherein said first, second, and third compartments are formed in a linear arrangement.

21. A method of packaging a plurality of parts for assembling an item, the method comprising the steps of:
providing a plurality of parts;
providing a plurality of compartments for packaging said plurality of parts, wherein said plurality of compartments include a first compartment and a second compartment; and
placing said plurality of parts in said plurality of compartments, wherein parts placed in said first compartment are utilized in a first assembly step, and parts placed in said second compartment are utilized in a second assembly step.

22. The method of claim 21, further comprising the step of:
providing instructions to assemble the item, wherein said instructions include at least the first assembly step and the second assembly step;

23. The method of claim 22, further comprising the steps of:
providing a third assembly step in the instructions to assembly the item;
providing a third compartment for packaging said plurality of parts; and
placing parts in said third compartment which are utilized in said third assembly step.

24. The method of claim 21, wherein the item is a furniture item.

25. The method of claim 21, wherein at least a portion of said plurality of parts is selected from the group consisting of screws, nuts, bolts, nails, anchors, washers, cams, pins, dowels, and an Allen wrench.

26. The method of claim 21, further comprising the step of:
providing an identifier associated with each of said first and second compartments, wherein each identifier indicates the assembly step corresponding with the parts packaged in each compartment.

27. The method claim 21, further comprising the step of:
providing instructions to assemble the item which indicate that one should first remove the parts within said first compartment, and thereafter remove the parts within said second compartment after the first assembly step is completed.
